(19) United States
(12) Patent Application Publication
(10) Pub. No.: US 2013/0118324 A1
(43) Pub. Date: May 16, 2013

(54) METHOD FOR FASTENING A TOOL HANDLE TO A TOOL SHAFT

(71) Applicant: Symmetry Medical New Bedford, Inc., New Bedford, MA (US)

(72) Inventor: LEO F. GOWIN, JR., ABINGTON, MA (US)

(73) Assignee: SYMMETRY MEDICAL NEW BEDFORD, INC, NEW BEDFORD, MA (US)

(21) Appl. No.: 13/669,592

(22) Filed: Nov. 6, 2012

Related U.S. Application Data
(60) Provisional application No. 61/558,008, filed on Nov. 10, 2011.

(51) Int. Cl. B25G 3/24

(52) U.S. Cl. 81/489; 29/517

(57) ABSTRACT

A method for fastening a tool handle to a tool shaft includes the following steps. First, providing a tool shaft comprising an elongated body having a proximal end and a distal end. Next, providing a tool handle comprising a distal end, a proximal end and a socket formed at the distal end. Next, inserting the proximal end of the tool shaft into the socket of the tool handle, and then staking the proximal end of the tool shaft to the tool handle from two opposite directions.

### CROSS REFERENCE TO RELATED CO-PENDING APPLICATIONS

This application claims the benefit of U.S. provisional application Ser. No. 61/558,008 filed on Nov. 10, 2011 and entitled METHOD FOR FASTENING A TOOL HANDLE TO A TOOL SHAFT which is commonly assigned and the contents of which are expressly incorporated herein by reference.

### FIELD OF THE INVENTION

The present invention relates to an ergonomic tool handle, and to a method of fastening the tool handle to a tool shaft.

### BACKGROUND OF THE INVENTION

A conventional tool handle 50 usually includes a cylindrical body 10 having a proximal end 10a and a distal end 10ba. The distal end surface includes a socket 20, which is usually shaped and dimensioned to receive the proximal end 30a of an elongated tool shaft 30. The distal end 30b of the tool shaft usually has a specific tool shape or is attached to a tool end effector (not shown). The proximal end 30a of the elongated shaft is either permanently or removably attached to the socket 20 of the tool handle. Some of the attachment methods include welding, press-fitting of the shaft end into the socket, or screwing the threaded shaft end 30a into a threaded socket. Most of these attachment methods require high precision manufactured components or specialized production methods and tools, which increase the overall cost of the tool.

It would be desirable to use a tool handle attachment method that does not require high precision manufactured components or specialized methods and tools.

### SUMMARY OF THE INVENTION

The present invention provides a tool handle attachment method that does not require high precision manufactured components or specialized methods and tools. A tool shaft is inserted into a tool handle opening and is subsequently attached to the tool handle via staking from two opposite directions.

In general, in one aspect, the invention features method for fastening a tool handle to a tool shaft including the following steps. First, providing a tool shaft comprising an elongated body having a proximal end and a distal end. Next, providing a tool handle comprising a distal end, a proximal end and a socket formed at the distal end. Next, inserting the proximal end of the tool shaft into the socket of the tool handle, and then staking the proximal end of the tool shaft to the tool handle from two opposite directions.

Implementations of this aspect of the invention may include one or more of the following features. The distal end of the tool handle includes first and second opposite recesses extending from the top and bottom surface of the tool handle, respectively, toward the socket wall and being oriented perpendicular to the socket axis. Each recess includes conical side walls and a flat bottom surface. A thin layer of material separates the flat bottom surfaces of the recesses from the socket wall. The staking includes inserting first and second stakes into the first and second opposite recesses, and punching the first and second stakes into the first and second recesses, respectively, thereby forcing the flat bottom surfaces of the recesses toward the socket wall without breaking the thin layer of material, and creating matching indentations in the flat bottom surfaces and the outer surface of the tool shaft, respectively. Each stake includes a cylindrical body terminating into a conical end and the conical end includes a conical base and two flat inclined surfaces terminating into a common narrow front flat surface. The cylindrical body includes a recess cutout surface extending longitudinally along the stake axis and the recess cutout surface is oriented perpendicular to the common narrow front flat surface. The first and second stakes are punched simultaneously into the first and second recesses, respectively. The tool handle includes a cylindrical body with a rounded rear surface and a flat front surface, and the cylindrical body includes a concave central section and flutes arranged around the perimeters of the proximal and distal ends. The distal end of the tool handle includes a conical outer surface that is angled relative to the outer surface of the cylindrical body. The tool shaft terminates in an end effector or tool tip.

In general, in another aspect, the invention features a device including a tool shaft comprising an elongated body having a proximal end and a distal end, and a tool handle comprising a distal end, a proximal end and a socket formed at the distal end. The tool handle is fastened to the tool shaft by inserting the proximal end of the tool shaft into the socket of the tool handle and then staking the proximal end of the tool shaft to the tool handle from two opposite directions.

Among the advantages of this invention may be one or more of the following. The tool handle has an ergonomic design that includes a concave central section, stabilization flutes and a spherical end. The concave central section of the tool handle facilitates grasping the tool handle from a flat surface and the stabilization flutes prevent rolling of the tool handle on a flat surface. The stabilization flutes also provide visual and tactile means for orienting the tool tip or end effector during use. The spherical rear surface of the tool handle allows it to rest comfortably in the user's palm and to be easily rotated and manipulated with the user's fingers. The tool handle attachment method does not require any additional mechanical components, high precision equipment or process. The method is economical and fast. The thin layer of material that separates the handle from the shaft does not break through and remains intact after the staking. This maintains a seal between the handle and the shaft and prevents contaminants from entering the tool handle opening during use. This provides benefits in cleaning and sterilization of the tool handle. There is no visible discoloration or damage of the tool handle after the attachment, and therefore the handle does not require any subsequent polishing or finishing. Preliminary mechanical testing results indicate that the attached tool handle exceeds the strength requirements for most surgical tool applications.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 is a schematic diagram of a prior art tool handle;

FIG. 2 is side elevational view of a tool handle attached to a tool shaft, according to this invention;

FIG. 3 is a front elevational view of the tool handle of FIG. 2;

FIG. 4 is a cross-sectional view of the tool handle of FIG. 2;

FIG. 5 is a detailed view of area A of FIG. 4;

FIG. 6 is a detailed view of area A during the staking process;

FIG. 7 is a the top view of the tool handle of FIG. 2 prior to the staking process;

FIG. 8 is a the top view of the tool handle of FIG. 2 after the staking process;

FIG. 9 is a cross-sectional view of the tool handle of FIG. 2 after the staking process;

FIG. 10 is perspective view of the tool shaft after the staking process;

FIG. 11 depicts a front elevational view of the tool handle with typical dimensions;

FIG. 12 depicts a side elevational view of the tool handle with typical dimensions;

FIG. 13 is a detailed view of area A prior to the staking process with typical dimensions;

FIG. 14 is top elevational view of the tool handle;

FIG. 15 is a bottom elevational view of the tool handle;

FIG. 16 is a front elevational view of the stake used in the staking process with typical dimensions;

FIG. 17 is a side elevational view of the stake used in the staking process with typical dimensions;

FIG. 18 is a detailed side view of the stake tip;

FIG. 19 is a top view of the stake tip;

FIG. 20 is a perspective view of the tool handle;

FIG. 21 is a top view of the tool handle of FIG. 20; and

FIG. 22 is a bottom view of the tool handle of FIG. 20

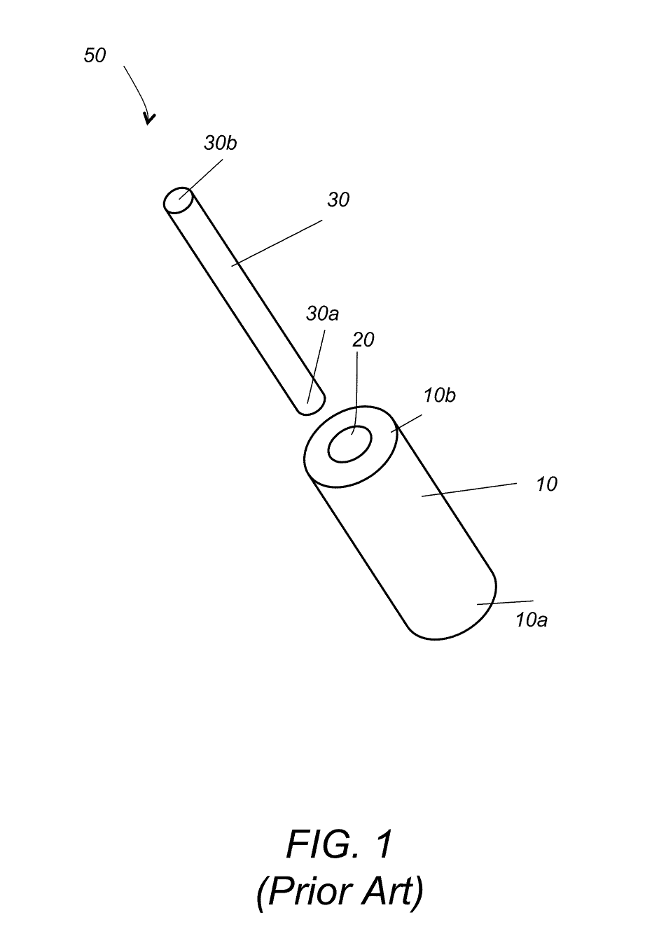

### DETAILED DESCRIPTION OF THE INVENTION

The present invention provides a tool handle attachment method that does not require high precision manufactured components or specialized methods and tools. A tool shaft is inserted into a tool handle opening and is subsequently attached to the tool handle via staking from two opposite directions.

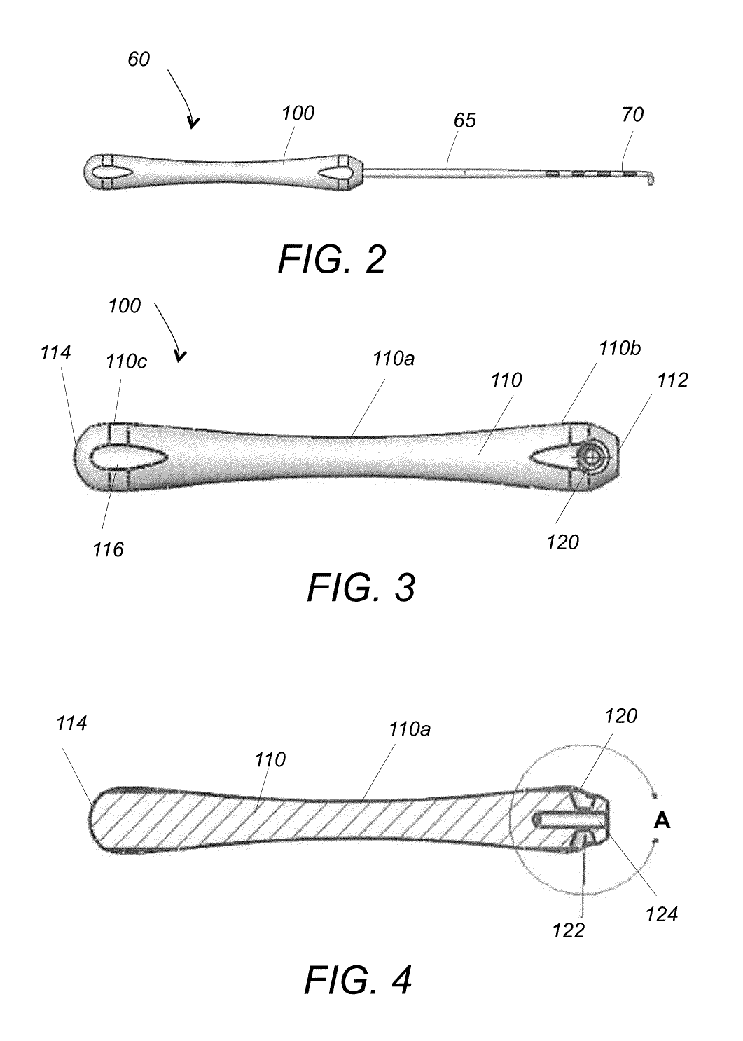

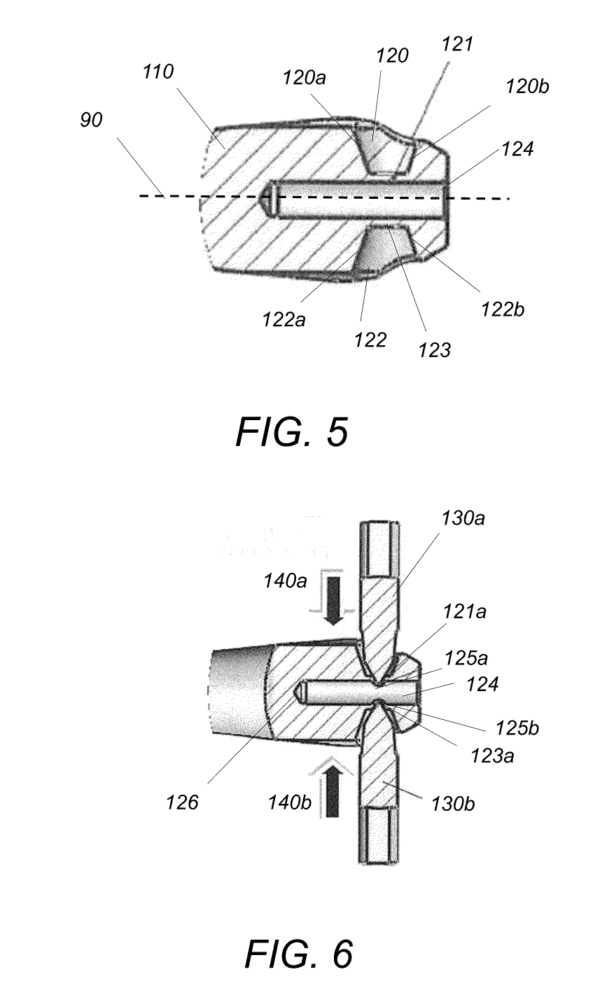

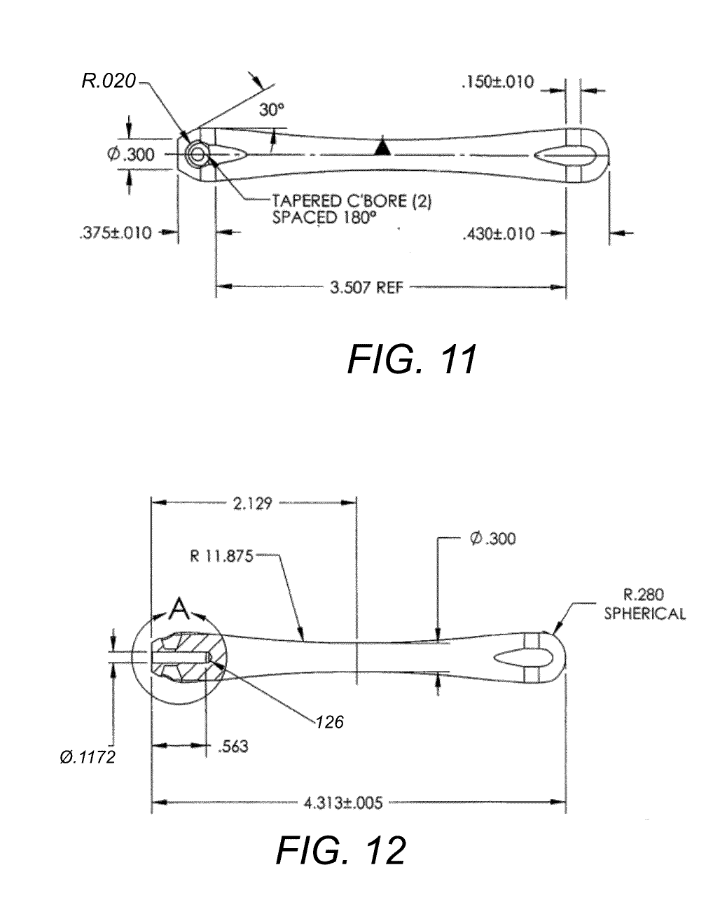

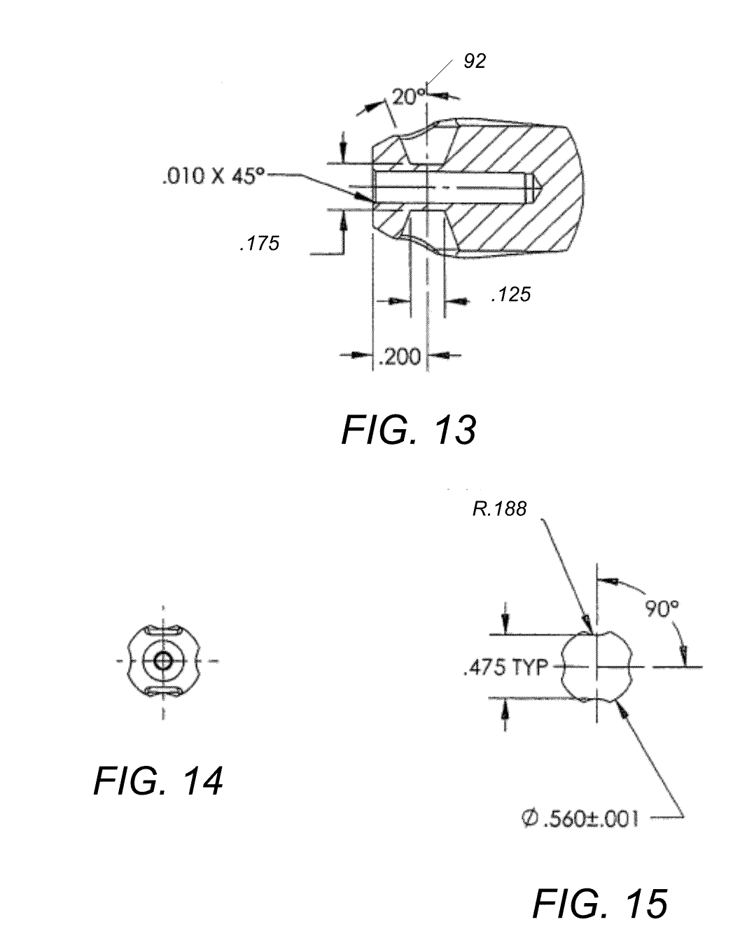

Referring to FIG. 2, instrument 60 includes an ergonomic tool handle 100 and tool shaft 65. Tool shaft 65 terminates in an end effector or tool tip 70. Tool handle 100 has a cylindrically shaped body 110 with a rounded rear surface 114 and a flat front surface 112, shown in FIG. 3. The cylindrical body 110 has a concave central section 110a and flutes 116 arranged around the perimeters of the proximal end 110c and distal end 110b. The concave central section 110a facilitates grasping the tool handle 100 from a flat surface and flutes 116 prevent rolling of the tool handle on a flat surface. Flutes 116 also provide visual and tactile means for orienting the tool tip or end effector 70 during use. The spherical rear surface 114 of the tool handle 10 allows it to rest comfortably in the user's palm and to be easily rotated and manipulated with the user's fingers. The flat front surface 112 includes an axial opening (socket) 124 terminating at point 126, as shown in FIG. 5, and FIG. 6. The distal end 110b of the tool handle has a conical outer surface that is angled relative to the outer surface of the cylindrical body 110. The angled surface of the distal end 110a includes two opposite recesses 120, 122, extending from the top and bottom of the tool, respectively, and being oriented perpendicular to the socket axis 90, as shown in FIG. 5. In one example, the angle between the conical distal end surface and the cylindrical body surface is 30 degrees, as shown in FIG. 11. Recess 120 has conical side walls 120a, 120b and a flat bottom end 121. Similarly, recess 122 has conical side walls 122a, 122b and flat bottom end 123. A thin layer of material separates the flat bottom ends 121, 123 from the axial opening 124. In one example, the thin layer of material has a thickness of about 0.06 inches. Typical dimensions of the tool handle 100 are shown in FIG. 11-FIG. 15. In one example, the handle 100 has a length of 4.4 inches, a radius of 0.56 inch, a circular front surface with a diameter of 0.3 inch, a spherical rear surface with a curvature radius 0.280 inch, concave central section 110a with a curvature radius 11.875 inch, an axial front opening 124 with a diameter of 0.117 inch and an opening length of 0.563 inch, top and bottom recesses 120, 122 having a bottom diameter of 0.125 inch and side walls angled by 20 degrees relative to axis 92, shown in FIG. 13.

Referring to FIG. 6, the process of attaching the toll handle distal end 110b to the proximal end of the shaft 65 includes the following steps. First, the proximal end of the cylindrical shaft 65 is inserted into opening 124 of the tool handle. Next, two stakes 130a, 130b are placed into recesses 120, 122, respectively, and the stakes 130a, 130b are then punched down along directions 140a, 140b, respectively. This staking process, forces the bottom surfaces 121, 123 of the recesses 120, 122, respectively, into the cylindrical shaft 65, and creates indentations 121a, 123a in the bottom surfaces 121, 123, respectively, and indentations 125a, 125b in opposite sides of the cylindrical shaft 65. Tool handle indentations 121a, 123a match and cooperate with shaft indentations 15a, 125b, respectively, to fixedly attach the tool handle 100 to the shaft 65. The thin layer of material that separates the flat bottom ends 121, 123 from the axial opening 124 does not break through and remains intact after the staking. This is achieved by using stakes with specific geometric shape.

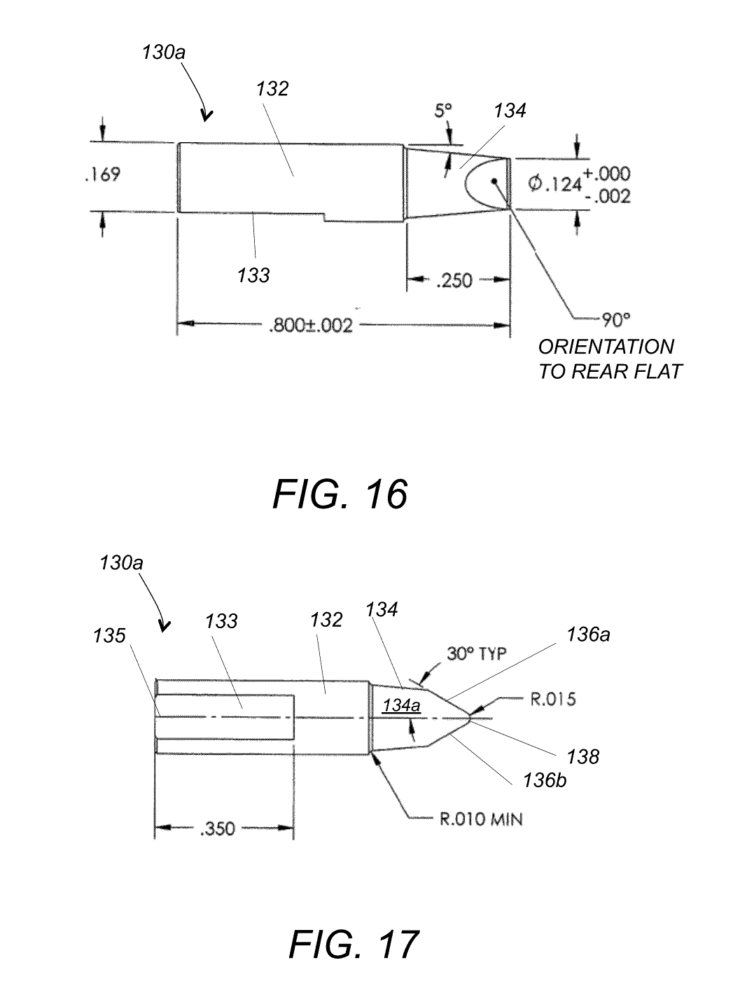

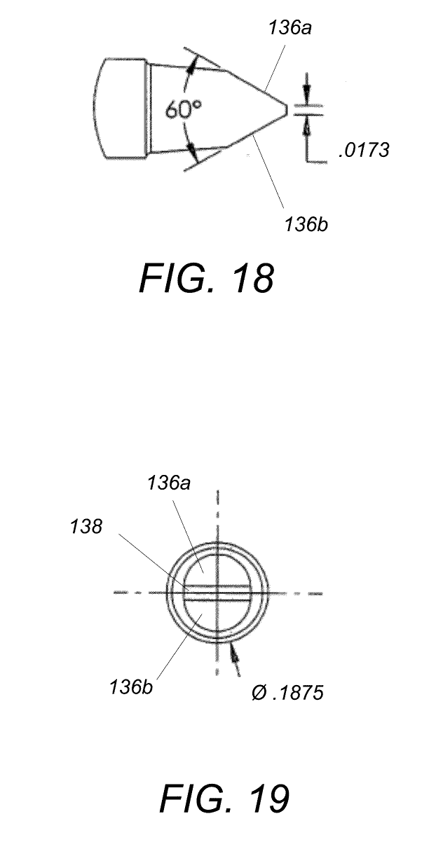

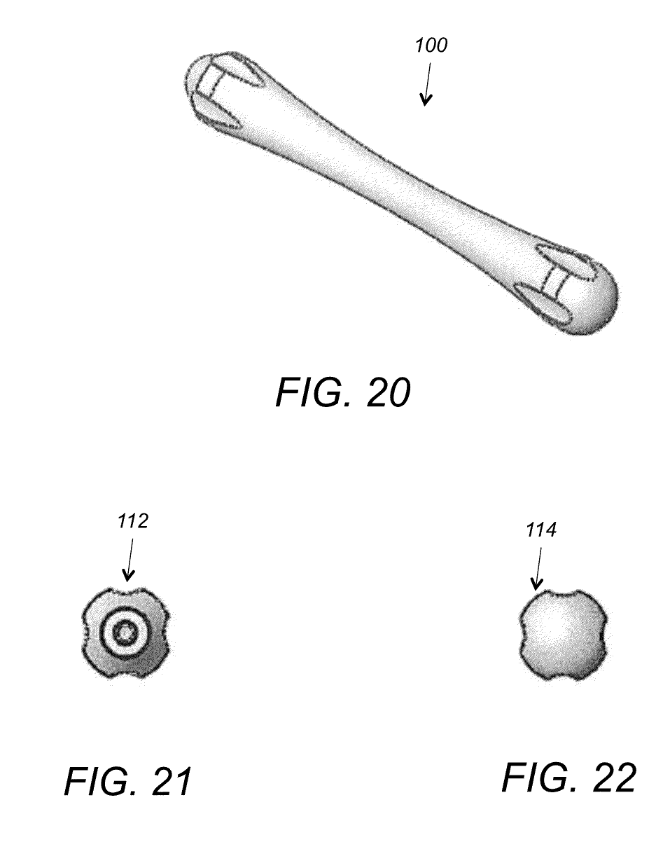

Referring to FIG. 16-FIG. 19, stake 130a has a basically cylindrical body 132 with a conical tip 134. Cylindrical body 132 includes a recess cutout 133 extending longitudinally along axis 135, shown in FIG. 17. Recess cutout 133 is used for orienting conical tip 134 in the stacking fixture, in order to ensure proper orientation of the deformed material. Conical tip 134 includes a conical base 134a and two angled front surfaces 136a, 136b meeting each other at a narrow font flat surface 138, shown in FIG. 17. In one example, surfaces 136a, 136b form 30 degrees angles with axis 135 and front surface 138 has a width of 0.0173 inch. The radius of the conical tip base is 0.1875 inch and the length is 0.250 inch. In this example, stake 130a has a length of 0.8 inch, a radius of 0.169 inch and the recess 133 has a length of 0.350 inch.

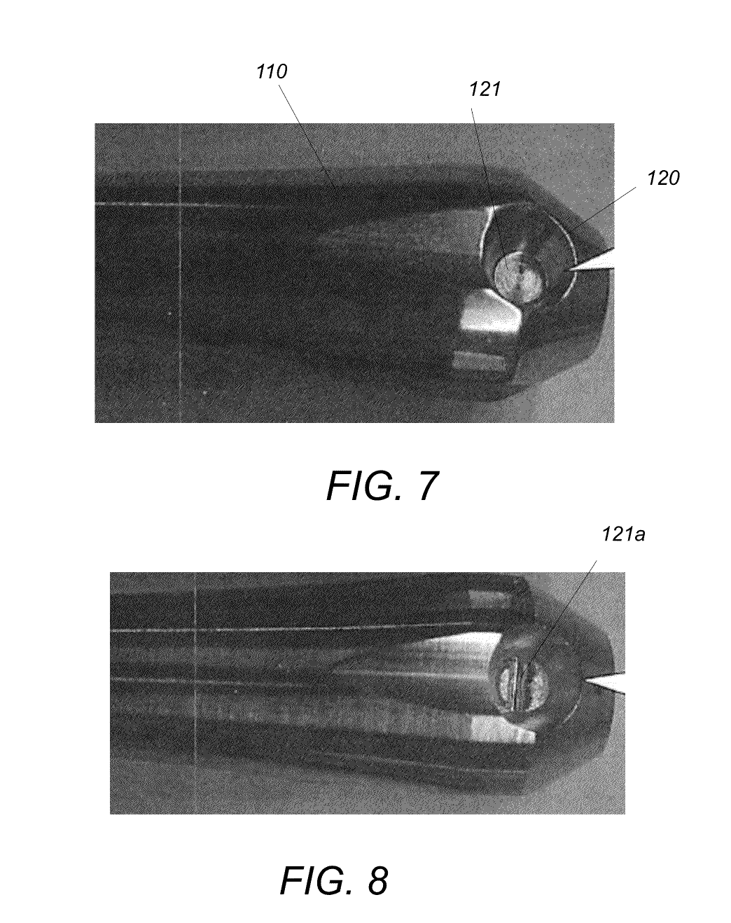

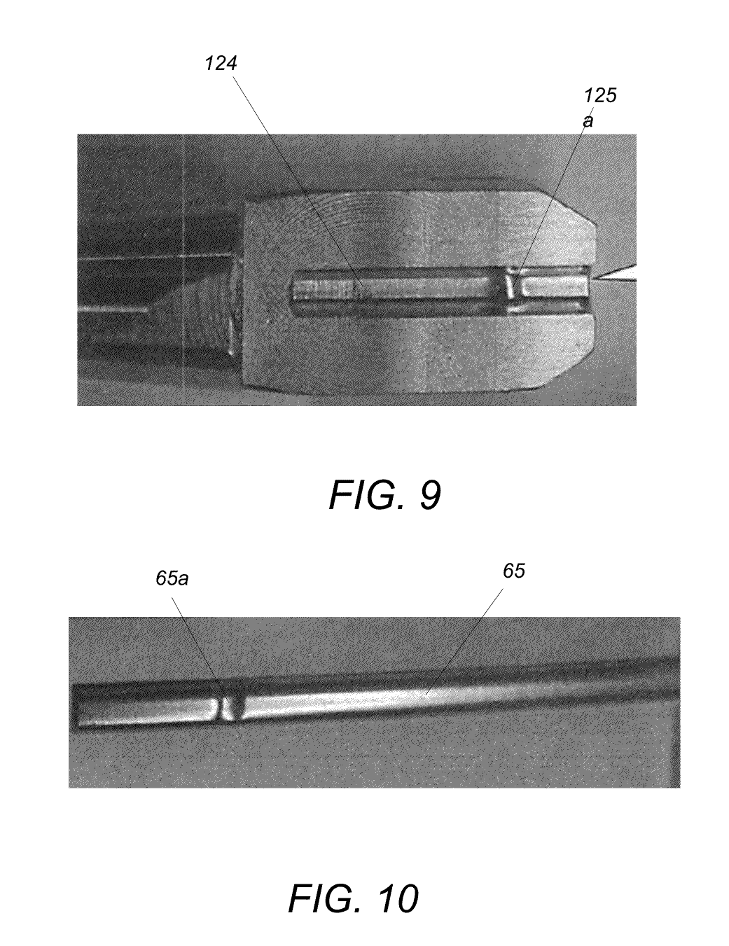

The thin layer of material that separates the handle from the shaft does not break through and remains intact after the staking. This maintains a seal between the handle and the shaft and prevents contaminants from entering the tool handle opening during use. This also provides benefits in cleaning and sterilization of the tool handle. Furthermore, there is no visible discoloration or damage of the tool handle after the attachment and therefore, the handle does not require any subsequent polishing or finishing, as shown in FIG. 7 and FIG. 8. Preliminary mechanical testing results indicate that the attached tool handle exceeds the strength requirements for most surgical tool applications. The mechanical testing included a pull test, a torsion test and a destructive test. In the destructive test, the handle was cut in half in order to observe the effect of the staking punch on the shaft and the tool handle opening, as shown in FIG. 9 and FIG. 10.

Several embodiments of the present invention have been described. Nevertheless, it will be understood that various modifications may be made without departing from the spirit and scope of the invention. Accordingly, other embodiments are within the scope of the following claims.

What is claimed is:

1. A method for fastening a tool handle to a tool shaft comprising:
providing a tool shaft comprising an elongated body having a proximal end and a distal end;
providing a tool handle comprising a distal end, a proximal end and a socket formed at the distal end;
inserting the proximal end of the tool shaft into the socket of the tool handle;
staking the proximal end of the tool shaft to the tool handle from two opposite directions.

2. The method of claim 1, wherein the distal end of the tool handle comprises first and second opposite recesses extending from the top and bottom surface of the tool handle, respectively, toward the socket wall and being oriented perpendicular to the socket axis.

3. The method of claim 2, wherein each recess comprises conical side walls and a flat bottom surface and wherein a thin layer of material separates the flat bottom surfaces of the recesses from the socket wall.

4. The method of claim 3, wherein said staking comprises inserting first and second stakes into the first and second opposite recesses, and punching the first and second stakes into the first and second recesses, respectively, thereby forcing the flat bottom surfaces of the recesses toward the socket wall without breaking the thin layer of material, and creating matching indentations in the flat bottom surfaces and the outer surface of the tool shaft, respectively.

5. The method of claim 4, wherein each stake comprises a cylindrical body terminating into a conical end and wherein the conical end comprises a conical base and two flat inclined surfaces terminating into a common narrow front flat surface and wherein the cylindrical body comprises a recess cutout surface extending longitudinally along the stake axis and wherein said recess cutout surface is oriented perpendicular to the common narrow front flat surface.

6. The method of claim 4, wherein the first and second stakes are punched simultaneously into the first and second recesses, respectively.

7. The method of claim 1, wherein the tool handle comprises a cylindrical body with a rounded rear surface and a flat front surface, and wherein the cylindrical body comprises a concave central section and flutes arranged around the perimeters of the proximal and distal ends.

8. The method of claim 7, wherein the distal end of the tool handle comprises a conical outer surface that is angled relative to the outer surface of the cylindrical body.

9. The method of claim 1, wherein said tool shaft terminates in an end effector or tool tip.

10. A device comprising:
a tool shaft comprising an elongated body having a proximal end and a distal end;
a tool handle comprising a distal end, a proximal end and a socket formed at the distal end;
wherein the tool handle is fastened to the tool shaft by inserting the proximal end of the tool shaft into the socket of the tool handle and then staking the proximal end of the tool shaft to the tool handle from two opposite directions.

11. The device of claim 10, wherein the distal end of the tool handle comprises first and second opposite recesses extending from the top and bottom surface of the tool handle, respectively, toward the socket wall and being oriented perpendicular to the socket axis.

12. The device of claim 11, wherein each recess comprises conical side walls and a flat bottom surface and wherein a thin layer of material separates the flat bottom surfaces of the recesses from the socket wall.

13. The device of claim 12, wherein said staking comprises inserting first and second stakes into the first and second opposite recesses, and punching the first and second stakes into the first and second recesses, respectively, thereby forcing the flat bottom surfaces of the recesses toward the socket wall without breaking the thin layer of material, and creating matching indentations in the flat bottom surfaces and the outer surface of the tool shaft, respectively.

14. The device of claim 13, wherein each stake comprises a cylindrical body terminating into a conical end and wherein the conical end comprises a conical base and two flat inclined surfaces terminating into a common narrow front flat surface and wherein the cylindrical body comprises a recess cutout surface extending longitudinally along the stake axis and wherein said recess cutout surface is oriented perpendicular to the common narrow front flat surface.

15. The device of claim 10, wherein the tool handle comprises a cylindrical body with a rounded rear surface and a flat front surface, and wherein the cylindrical body comprises a concave central section and flutes arranged around the perimeters of the proximal and distal ends.

16. The device of claim 15, wherein the distal end of the tool handle comprises a conical outer surface that is angled relative to the outer surface of the cylindrical body.

17. The device of claim 10, wherein said tool shaft terminates in an end effector or tool tip.
